(19) United States
(12) Patent Application Publication
(10) Pub. No.: US 2004/0007142 A1
(43) Pub. Date: Jan. 15, 2004

(54) Apparatus for treating lignocellulose material and method associated thereto

(75) Inventors: Paul Jollez, Sherbrooke (CA); Sylvain Cloutier, Rock Forest (CA)

Correspondence Address: DARBY & DARBY P.C., P. O. BOX 5257, NEW YORK, NY, 10150-5257, US

(73) Assignee: Kemestrie Inc., Sherbrooke (CA)

(21) Appl. No.: 10/431,344

(22) Filed: May 6, 2003

(30) Foreign Application Priority Data
May 6, 2002 (CA) 2,383,279

(51) Int. Cl. B30B 9/12; B30B 9/14; B30B 9/16; B30B 9/18; D21F 5/00; F25C 5/14; D21F 5/16; H05B 6/00; H05B 6/14; B30B 9/20; B02C 11/08; F26B 13/00; B30B 15/34; B21B 27/00; B32B 31/20; B29C 33/02; B29C 43/52

(52) U.S. Cl. 100/337; 100/117

(57) ABSTRACT

An apparatus for treating material, such as lignocellulose material, fibrous material, particulate material, cellulosic material, and the like. The apparatus includes a feed system, a reactor, a conveyor, and a discharge system. The feed system has an inlet for receiving the material from a supply source at ambient pressure conditions and an outlet for releasing the material. The reactor is used for treating the material and has an inlet connected to the outlet of the feed system for receiving the material released from the feed system, and an outlet for releasing the material treated by the reactor. The conveyor is located inside the reactor for conveying the material from the inlet of the reactor to the outlet thereof. The discharge system is used for discharging the material and has a chamber and a pump. The chamber has an inlet connected to the outlet of the reactor for receiving the material treated by the reactor, and an outlet. The pump is connected to the chamber for pumping liquid into the chamber so as to put the treated material received from the reactor in liquid suspension, thereby obtaining a liquid suspended treated material, said liquid suspended treated material being dischargeable from the apparatus into ambient pressure conditions through the outlet of the chamber.

### FIELD OF THE INVENTION

The present invention relates to an apparatus and method for treating lignocellulose material, fibrous material, particulate material, and the like, in a chamber, with gaseous reagents, such as steam for example, under pressurized conditions. More particularly, the present invention relates to an apparatus and method which is also devised for cooling and discharging such treated material from the chamber in which gaseous reagents are maintained under pressure, in such a way, that the treated material is discharged without explosive depressurization which typically results from high temperature gradients.

### BACKGROUND OF THE INVENTION

Apparatuses and methods for treating lignocellulose material, fibrous material, particulate material, and the like, in a chamber with gaseous reagents, such as steam for example, under pressurized conditions, are very well known in the art.

Known in the art, there is Canadian Patent No. 1,070,537 granted on Jan. 29^{th}, 1980, and naming Brown et al. as inventors, which relates to a method of feeding fibrous material into a pressurized vessel such as a digester operating at approximately 300 pounds per square inch. The raw material is first pre-compacted by a screw conveyor and subsequently compacted to a density of at least 45 pounds per cubic foot of oven dry material to form a plug in a feeding conduit communicating with the digester. During the precompacting and compacting stage, the moisture of the material is maintained at a natural level of about 10% to 50% by weight. The plug thus forms a continuously advancing mass of material which separates the interior of the digester from the surrounding atmosphere without the need of special valve means normally used in prior art. The advancement of the plug takes place along a straight line generally coincident with the centreline of the screw conveyor but axially spaced from the same.

Also known in the art, there is U.S. Pat. No. 4,211,163 granted on Jul. 8^{th}, 1980, and naming Brown et al. as inventors, which relates to an apparatus for discharge of pressure cooked particulate or fibrous material. Particulate or fibrous material, after treatment with gaseous reagents in a vessel under pressure in a continuous process, is discharged from the pressure vessel by entering a discharge conduit in pressure communication with the pressure vessel, and is conveyed through the discharge conduit by means of a feed conveyor located therein. The feed conveyor compacts the material to form a dense, substantially gas impervious plug thereof in the discharge conduit against the outlet end thereof. The outlet end of the discharge conduit comprises an exit passage of small cross-sectional area so as to cause compaction of the material therein by means of the conveyor. A valve means is provided, movable rapidly between a fully open position and a fully closed position to permit passage of the cooked material therethrough, from the dense, compact plug formed in the outlet end of the discharge conduit. Operating means is provided to move the valve rapidly between its fully opened and fully closed positions, at predetermined intervals. In this means, the cooked material can be discharged intermittently at frequent intervals from a pressure vessel, allowing the pressure cooking process to be conducted continuously. The dense compact plug prevents reagent losses and pressure losses on discharge of the material.

A major problem associated with the above-mentioned types of apparatuses and methods is that the material being treated under high pressure and temperature conditions generally has a tendency to burst and/or defiberize due to explosive depressurization which results often from high temperature gradient between the treatment conditions in the vessel and the environment in which the treated material is discharged. Another problem associated with the above-mentioned types of apparatuses and methods is that a loss of pressure in the treatment vessel has been known to arise when the treated material is discharged from the apparatus due to the nature of the discharged system of said apparatuses. Moreover, another substantial disadvantage of the above-mentioned apparatuses is that there has been known to be possible pressure variations in the area close to the discharging outlet of the apparatuses, which is disadvantageous as known in the art. In addition, the above-mentioned apparatuses are disadvantageous in that the treated material may behave randomly, due to suction effects in this area close to the discharge area, because the transfer speed is difficult to control. Moreover, these above-mentioned apparatuses are disadvantageous because they have been known to be subject to a loss of volatiles and the treated material which is discharged from the apparatuses is done under extreme conditions, very often leading to significant impact of the treated product onto components and conduits of the apparatuses, which as a result thereof, often require maintenance and/or replacement.

Another substantial problem associated with the above-mentioned types of devices is that the material to be treated requires to be formed into a plug, either at the upstream level of the pressurized vessel, or at the downstream level of the pressurized vessel, so as to ensure that substantial pressure losses will not result when the material is either entered or discharged from said pressurized vessel.

Hence, in light of the aforementioned, there is a need for an improved apparatus and/or method for treating lignocellulose material, fibrous material, particulate material, and the like, which would be able to overcome some of the aforementioned problems.

### SUMMARY OF THE INVENTION

The object of the present invention is to provide an apparatus for treating lignocellulose material, fibrous material, particulate material, and the like, which, by virtue of its design and components, satisfies some of the above-mentioned needs and is thus an improvement over other related apparatuses and/or methods known in the prior art.

In accordance with the present invention, the above object is achieved with an apparatus for treating material, said apparatus comprising:

a feed system having an inlet for receiving the material from a supply source and an outlet for releasing the material;

a reactor for treating the material, the reactor having an inlet connected to the outlet of the feed system for receiving the material released from the feed system, and an outlet for releasing the material treated by the reactor;

a conveyor located inside the reactor for conveying the material from the inlet of the reactor to the outlet thereof; and

a discharge system for discharging the material, the discharge system including:

a chamber having an inlet connected to the outlet of the reactor for receiving the material treated by the reactor, and an outlet; and

a pump connected to the chamber for pumping liquid into the chamber so as to put the treated material received from the reactor in liquid suspension, thereby obtaining a liquid suspended treated material, said liquid suspended treated material being dischargeable from the apparatus through the outlet of the chamber.

Preferably, the material is selected from the group consisting of lignocellulose material, fibrous material, particulate material, cellulosic material, and the like.

According to another aspect of the present invention, there is also provided an apparatus for treating lignocellulose material, said apparatus comprising:

a feed system having an inlet for receiving the material from a supply source at ambient pressure conditions and an outlet for releasing the material under pressurized conditions;

a reactor for treating the material under pressurized conditions, the reactor having an inlet connected to the outlet of the feed system for receiving the material released from the feed system, and an outlet for releasing the material treated by the reactor under pressurized conditions;

a conveyor located inside the reactor for conveying the material from the inlet of the reactor to the outlet thereof; and

a discharge system for discharging the material, the discharge system including:

a chamber under pressurized conditions having an inlet connected to the outlet of the reactor for receiving the material treated by the reactor, and an outlet; and

a pump connected to the chamber for pumping liquid into the chamber under pressurized conditions so as to put the treated material received from the reactor in liquid suspension, thereby obtaining a liquid suspended treated material, said liquid suspended treated material being dischargeable from the apparatus into ambient pressure conditions through the outlet of the chamber.

Preferably, the outlet of the chamber is provided with a valve, said valve being operable between a closed configuration for preventing discharging of the liquid suspended treated material from the chamber and an opened configuration for allowing discharging of the liquid suspended treated material from the chamber.

According to yet another aspect of the present invention, there is also provided a method for treating material, the method comprising the steps of:

a) feeding the material into a reactor;

b) conveying the material inside the reactor along the same for treating said material;

c) transferring the material treated by the reactor into a chamber;

d) pumping liquid into the chamber so as to obtain a liquid suspended treated material in the chamber; and

e) discharging the liquid suspended treated material from the chamber.

Preferably, step b) further comprises the step of injecting a gaseous reagent into the reactor for treating the material.

Preferably also, step e) comprises the steps of:

i) measuring parameters of the liquid suspended treated material present in the chamber; and

ii) discharging the liquid suspended treated material from the chamber when the parameters measured in step i) correspond to predetermined threshold values.

Preferably, the parameters are selected from the group of level, temperature, and degree of suspension.

Preferably also, step a) may comprise the step of impregnating the material with at least one reagent.

The objects, advantages and other features of the present invention will become more apparent upon reading of the following non-restrictive description of preferred embodiments thereof, given for the purpose of exemplification only with reference to the accompanying drawings.

### BRIEF DESCRIPTION OF THE DRAWINGS

FIG. 1 is a schematic representation of an apparatus for treating lignocellulose material according to a first preferred embodiment of the invention.

FIG. 2 is a schematic representation of an apparatus for treating lignocellulose material according to a second preferred embodiment of the invention.

FIG. 3 is a schematic representation of the discharge system of the apparatus shown in FIG. 2, said discharge system being shown cooperating with a control system.

FIG. 4 is an enlarged view of the chamber of the discharge system shown in FIG. 3, said chamber being shown provided with a level indicator.

### DETAILED DESCRIPTION OF PREFERRED EMBODIMENTS OF THE INVENTION

In the following description, the same numerical references refer to similar elements. The embodiments shown in the figures are preferred.

In the context of the present description, the expression “lignocellulose material” includes various types of materials, such as fibrous material, particulate material, cellulosic material, and the like. For this reason, the expression “lignocellulose” and/or other substantially related expressions should not be taken as to limit the scope of the present invention and includes all other kinds of materials or items with which the present invention may be used and could be useful, as apparent to a person skilled in the art.

Moreover, in the context of the present description, the expressions “apparatus” and “system”, “reactor” and “vessel”, “water” and “liquid”, as well as any other equivalent expressions and/or compound words thereof, may be used interchangeably. The same applies for any other mutually equivalent expressions, such as “treating” and “cooking” for example, as apparent to a person skilled in the art.

In addition, although the preferred embodiment of the present invention as illustrated in the accompanying drawings comprises various components such as a control system, level indicators, a timer, thermocouples, ball valves, a screw conveyor, a pump, etc., and although the preferred embodiment of the apparatus 1 and corresponding parts of the present invention as shown consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for apparatus 1 according to the present invention, as will be briefly explained herein and as can be easily inferred herefrom, without departing from the scope of the invention.

Broadly described, the apparatus 1 according to the present invention, as exemplified in the accompanying drawings, is an apparatus 1 for treating lignocellulose material, fibrous material, particulate material, and the like, which may be operated continuously or intermittently at frequent intervals. The material is preferably treated inside a reactor 5 by means of steam, under pressurized conditions, and at predetermined temperature levels. The material treated by the reactor 5 is then transferred into a discharge system 9, where it is cooled, and put into liquid suspension in an aqueous environment preferably, so as to subsequently be discharged into ambient pressure conditions without explosive depressurization, in order to maintain the integrity of the treated material, and thus prevent deterioration (bursting of cells, defiberizing, etc.) thereof.

The apparatus 1 may be used for different applications, such as cooking, mixing, and the like, whether operated continuously or intermittently at different intervals, as will be explained hereinbelow, and for treating under pressurized conditions a variety of materials such as lignocellulose material, fibrous material, particulate material, cellulosic material, and the like. Indeed, examples of cellulosic materials are poplar wood chips, straw, bagasse or the like material, which could be converted into nutritious fodder for example. As is known in the art, the lignocellulose material is of the type which may include a plurality of different lengths of the particles, e.g. from a complete length of straw stalks or stems to chopped straw, the material including wood chips but also different sorts of sawmill rejects, it being understood by a person skilled in the art that, for example, sawdust of so-called saw-flour type is in fact composed of minute particles of wood whose fibers are too short to fall within the scope of the term of “fibrous” material. Hence, several other materials may be used with the apparatus 1 according to the present invention, such as wood chips, fibers of various origins and dimensions, sawdust, flours, powders, fragments of organic products, etc., as apparent to a person skilled in the art. The apparatus 1 according to the present invention comprises a discharge system 9 which is devised to discharge liquid suspended treated material 15 without vaporization of the liquid and without bursting of the solid, as explained hereinbelow.

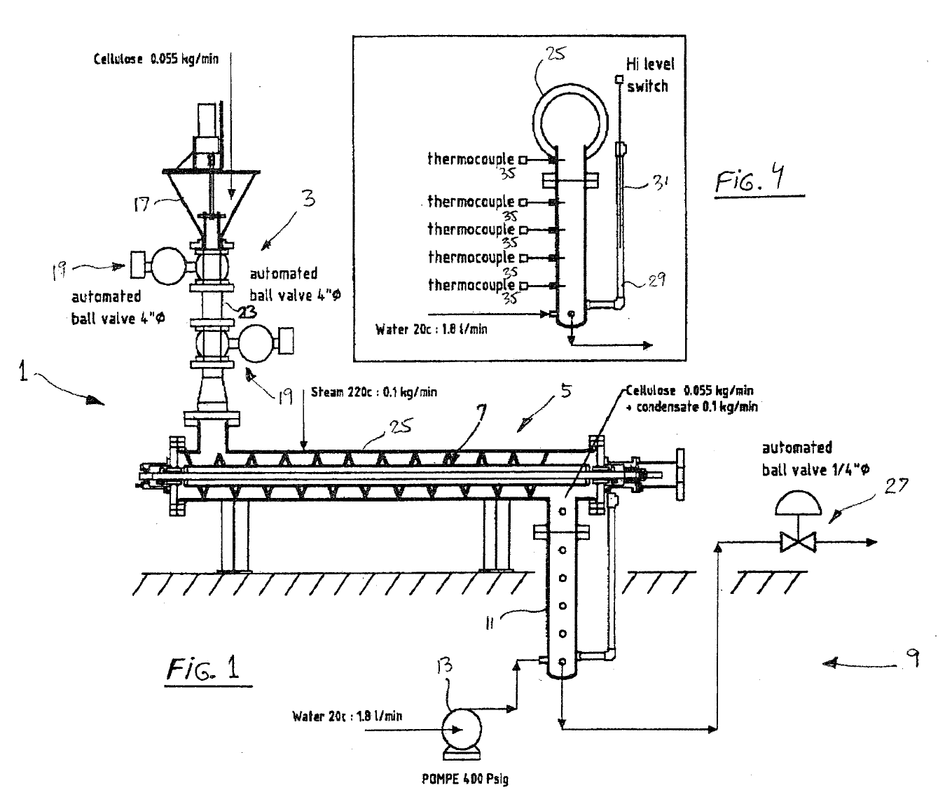

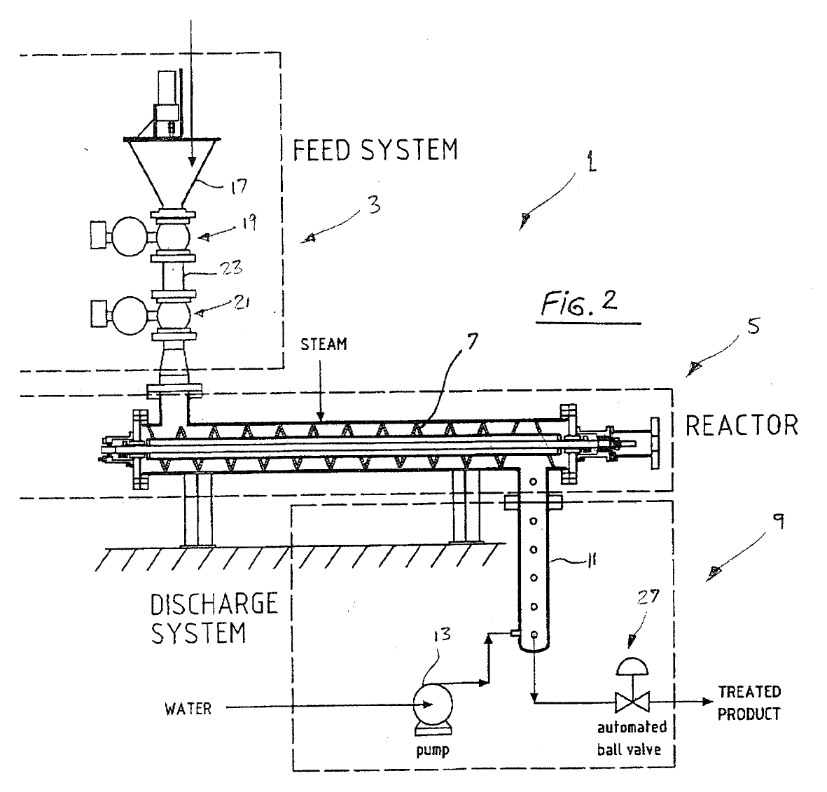

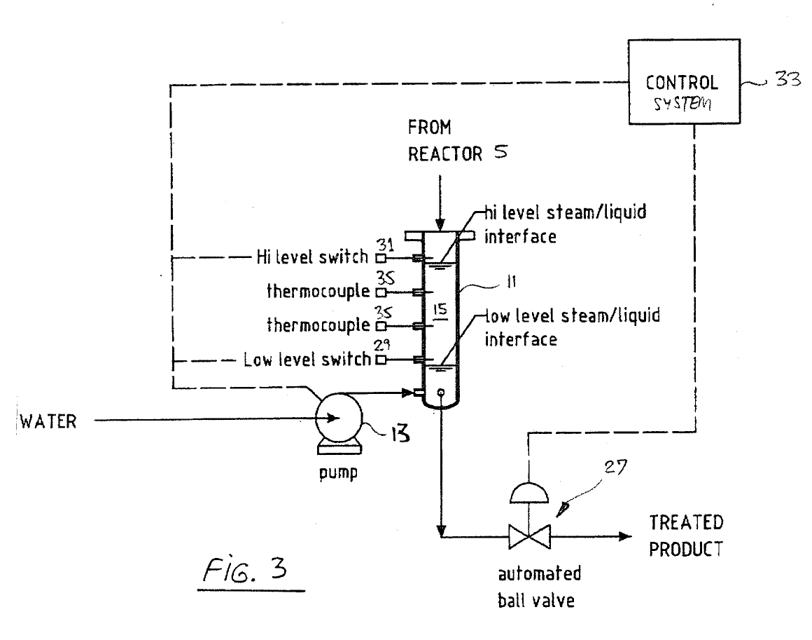

As better shown in FIGS. 1 and 2, the apparatus 1 for treating material according to the present invention preferably comprises a feed system 3, a reactor 5, a conveyor 7 and a discharge system 9. The feed system 3 has an inlet for receiving the material from a supply source and an outlet for releasing the material. The reactor 5 is used for treating the material, and has an inlet connected to the outlet of the feed system 3 for receiving the material released from the feed system 3, and an outlet for releasing the material treated by the reactor 5. The conveyor 7 is preferably located inside the reactor 5 for conveying the material from the inlet of the reactor 5 to the outlet thereof. The discharge system 9 is used for suitably discharging the material from the apparatus 1. The discharge system 9 comprises a chamber 11 having an inlet connected to the outlet of the reactor 5 for receiving the material treated by the reactor 5, and an outlet, as better shown in FIG. 3. The discharge system 9 also comprises a pump 13 connected to the chamber 11 for pumping liquid into the chamber 11 so as to put the treated material received from the reactor 5 in liquid suspension, thereby obtaining a liquid suspended treated material 15, said liquid suspended treated material 15 being dischargeable from the apparatus 1 through the outlet of the chamber 11, as can be easily understood when referring to FIGS. 2-4.

The feed system 3 is preferably intended to receive raw material to be treated at ambient pressure conditions into a feeding hopper 17. As better shown in FIG. 2, the feed system 3 preferably comprises first and second valves 19, 21, and a chamber 23 located thereinbetween. Raw material to be treated by the apparatus 1 is preferably inserted into the feed system 3 as follows. Firstly, the first and second valves 19, 21 are originally closed, and are preferably devised to never be opened at the same time. The first valve 19 is then opened, so as to allow raw material from the hopper 17 to be inserted into the chamber 23. Subsequently, the first valve 19 is closed, and the material located inside the chamber 23 is subjected to pressurized conditions similar to or substantially equal to that of the pressure conditions inside the reactor 5. Upon reaching suitable pressurized conditions, as apparent to a person skilled in the art, the second valve 21 is opened so as to allow the material to be treated, now under pressurized conditions, to suitably enter into the inlet of the reactor 5, as better shown in FIG. 2. The second valve 21 is then closed, and the cycle of the feed system 3 for feeding material to be treated into the reactor 5 is repeated, as can be easily understood. It is worth mentioning that other suitable types of feed systems 3 may be used according to the present invention, whether they be operated continuously, or intermittently, so long as they enable the raw material to be treated to be inserted into the reactor 5 under pressurized conditions similar to or substantially equal to those of the reactor 5, so as to enable a proper insertion of the material into the reactor 5, while also ensuring to minimize or prevent the loss of pressure, as apparent to a person skilled in the art. The above-mentioned chamber 23 of the feed system 3 located between the first and second valves 19, 21 preferably comprise suitable inlets connected thereto for pressurizing the chamber 23, and/or injecting liquid and/or gaseous reagents therein, as apparent to a person skilled in the art. Preferably also, the first and second valves 19, 21 are ball valves, although other types of valves 19, 21 may be used, as apparent to a person skilled in the art. Preferably also, the various components of the feed system 3 are suitably insulated from ambient conditions, as also apparent to a person skilled in the art.

As can be easily understood from the aforementioned, the opening and closing of the valves 19, 21 is preferably synchronized so as to enable to feed the reactor 5 with material to be treated at the same pressure than that of the reactor 5 by isolating the same from the ambient conditions of the raw material in the hopper 17. As aforementioned, other feed systems 3, which are well known in the art and widely used, such as the one described in the Canadian patent no. 1,070,037, which employs namely a system of reciprocating pistons, could be used. However, the latter requires the compaction of the material to be treated, in the form of a “plug”, and this way of feeding is, namely, fairly expensive and energy consuming. Thus, the above-discussed embodiment of feed system 3 is preferably used with the apparatus 1 according to the present invention, although other suitable feed systems 3, whether operated continuously or intermittently, may be employed, as apparent to a person skilled in the art. Indeed, the present feed system 3, as above-discussed, does not require to compact the material to be treated into a “plug”, which is advantageous with respect to the above-mentioned prior art feed system. Furthermore, the feed system 3 is preferably devised so as to introduce the material to be treated into the reactor 5, without depressurizing the same.

As better shown in FIG. 2, the apparatus 1 also comprises a reactor 5 in which the material is treated, in various ways, either by hydrolysis, cooking, and the like. Typically, the treatment of the material inside the reactor 5 is carried-out by means of gaseous reagent(s), such as steam for example, which is injected into the reactor 5, under pressurized conditions, and at suitable temperature levels, for adequately treating the material depending on the nature thereof. Gaseous reagents other than steam may be used according to the present invention, as apparent to a person skilled in the art.

Preferably, the reactor 5 comprises a vessel 25, which is preferably cylindrical, and supported by suitable supporting means, as better shown in FIGS. 1 and 2. The reactor 5 also comprises a conveyor 7 located inside the reactor 5 for conveying the material from the inlet of the reactor 5 to the outlet thereof. The conveyor 7 preferably comprises a screw conveyor 7 having a longitudinal shaft operated by a motor, preferably intended to rotate the same at variable speeds, depending on the conveying rate which is desired. The different parameters of the screw conveyor 7, such as the geometrical disposition of the helix, dimensions thereof, and the like, are preferably selected depending on the nature of the material to be treated, and the particular applications for which the apparatus 1 is intended, as apparent to a person skilled in the art. As better shown in FIGS. 1 and 2, the cylindrical vessel 25 is preferably disposed horizontally, and preferably is provided with several injection inlets for injecting gaseous reagents into the vessel 25, such as steam under pressure for example, although other suitable reagents may be used once again depending on the nature of the material to be treated and the particular applications for which the apparatus 1 is used. Preferably also, the reactor 5 is provided with various sensors disposed therealong for sensing temperature and pressure inside the vessel 25.

As aforementioned, the vessel 25 of the reactor 5 is preferably a cylindrical tube, which is preferably disposed horizontally, in order to, namely, facilitate the conveying of the product to be treated along the reactor 5. As aforementioned, the conveyor 7 preferably consists of an endless screw having a shaft rotatable about a fixed structure, for ensuring the transfer of the material to be treated inside the tube at a given speed enabling to adjustably control the time of treatment, i.e. the time of “cooking” of the material. The screw conveyor 7 may be rotated at different speeds, with the variable speed motor, so as to expose the material to be treated inside the reactor 5 at different cooking times, if desired. The screw conveyor 7 is preferably mounted at extremities of the fixed structure of the reactor 5, and said reactor 5 is preferably well insulated from its environment in order to avoid losses of heat and the condensation of a portion of the vapor injected therein.

As better shown in FIG. 2, the end portion of the conveyor 7 preferably has a helix portion contrary to the conveying portion to ensure that the material treated in the reactor 5 which ends at the extremity of the reactor 5 is suitably biased into the discharge system 9 via the inlet of the discharge chamber 11.

As also shown in FIG. 2, the discharge system 9 is preferably located at the end of the reactor 5, and comprises a chamber 11 which is preferably a substantially vertical tube having an inlet, preferably tapered, which is connected to the outlet of the reactor 5 for receiving the material treated by the reactor 5, and an outlet. This chamber 11 is mainly used for cooling and putting in liquid suspension the material treated by the reactor 5 so as to ensure proper discharging conditions prior to discharging the treated material into ambient conditions. Indeed, as better shown in FIG. 3, the outlet of the chamber 11 is preferably provided with a discharging valve 27 which enables to carry out the discharging of the treated product, after being cooled, while being kept under pressure, into a suitable receptor at atmospheric pressure. Because the treated material is in liquid suspension and has been substantially cooled, the resulting temperature gradient when the liquid suspended treated material 15 is discharged into ambient condition is therefore substantially reduced, and thus the integrity of the material is maintained, and said liquid suspended treated material 15 may be further processed, filtered, and/or the like, so as to obtain a desired product with the treated material.

As aforementioned, the outlet of the discharge chamber 11 is provided with a valve 27, said valve 27 being operable between a closed configuration for preventing discharge of the liquid suspended treated material 15 from the chamber 11 and an opened configuration for allowing discharging of the liquid suspended treated material 15 from the chamber 11. Due to the pressurized conditions inside the reactor 5 and the discharge chamber 11, the valve 27 is preferably selected to be operable between the opened and closed configurations, in a rapid manner, as apparent to a person skilled in the art. Preferably, a ball valve 27 is used, although other types of suitable valves 27 may also be used according to the present invention, as also apparent to a person skilled in the art.

According to the preferred embodiment of the invention, and as better shown in FIG. 3, the chamber 11 preferably comprises a first sensor 29, typically known as the “low level detector”, for detecting when the liquid suspended treated material 15 inside the chamber 11 is at a first level, i.e. the low level. Preferably also, the chamber 11 comprises a second sensor 31, known as the “high level detector”, for detecting when the liquid suspended treated material 15 inside the chamber 11 is at a second level, i.e. the high level. As better shown in FIGS. 3 and 4, the second level (high level) is located at a higher level than the first level (low level).

As can be easily understood, the pump 13 used for pumping liquid into the chamber 11 is preferably selected so as to have a positive displacement for injecting the liquid under pressure capable of overcoming the pressure inside the chamber 11, which is typically similar or substantially equal to that of the reactor 5, and thus enable to put the treated material conveyed into the chamber 11 in liquid suspension, so as to substantially cool-off the same due to the interaction with the liquid, and also enable it to be more easily dischargeable via the outlet of the chamber 11, thereby avoiding substantial pressure losses in the system.

As better shown in FIG. 3, the apparatus 1 preferably comprises a control system 33 operatively connected to the valve 27, for operating the same in the opened configuration upon of a signal from the second sensor 31 when the liquid suspended treated material 15 inside the chamber 11 reaches the second level, and for operating the valve 27 in the closed configuration upon reception of a signal from the first sensor 29 when the liquid suspended treated material 15 inside the chamber 11 falls to the first level.

Indeed, the opening and closing of the discharge valve 27 is carried out according to predetermined conditions of the liquid suspended treated material 15 inside the chamber 11 for proper discharging thereof. The liquid suspended treated material 15 is preferably discharged from the chamber 11 towards a receptor which is at atmospheric pressure until the low level detector 29 of the chamber 11 has been triggered, or after a certain predetermined time, and the discharge valve 27 is then closed so as to repeat the discharging cycle.

As can be easily understood, the flow rate of the pump 13 is adjusted so as to enable the formation of a transferable liquid suspended treated material 15, in order also to enable suitable cooling of the treated material inside the chamber 11, and also in order to ensure the discharging of the treated material from the system, without vaporization of the water nor bursting of the solid of the liquid suspended treated material 15.

The operation of the discharge valve 27 of the discharge system 9 may be carried out in various other suitable ways. Indeed, the control system 33 may be provided with a timer so as to alternatively operate the valve 27 in the closed and opened configurations during predetermined time intervals, as apparent to a person skilled in the art.

Moreover, the chamber 11 may be provided with at least one temperature sensor 35 for measuring the temperature of the liquid suspended treated material 15 inside the chamber 11, and the control system 33 may be devised so as to alternatively operate the valve 27 in the opened and closed configurations upon reception of corresponding signals from the at least one temperature sensor 35 according to predetermined temperature values measured by said at least one temperature sensor 35. Preferably, a plurality of temperature sensors 35 are disposed along the chamber 11 for measuring the temperature of the liquid suspended treated material 15 at different levels inside the chamber 11.

Moreover, a plurality of temperature and level sensors 35, 29, 31 are preferably disposed along the length of the chamber 11, and one or several injection lines for pumping liquid into the chamber 11 and cooling the treated material may be installed strategically along the chamber 11, as also apparent to a person skilled in the art.

The various sensors, such as thermocouples for example, disposed along the chamber 11 enable to namely, verify, if the temperature gradient of the cycle needs to be corrected by means of the debit water injected into the chamber 11 by the pump 13 and/or if the frequency of opening and closing of the discharging valve 27 needs to be adjusted. As aforementioned, the lateral or inferior inlets for injecting liquid, preferably cooled pressurized water, into the chamber 11, is carried out with a pump 13 with positive displacement able to overcome the pressurized conditions inside the chamber 11, as apparent to a person skilled in the art. The various components of the discharge system 9, such as the level detectors 29, 31, the temperature sensors 35, the pump 13, the valve 27, etc., are ail preferably connected to the control system 33 which operates and coordinates the discharge valve 27 (and pump 13) accordingly, as apparent to a person skilled in the art. As may now be better appreciated, and as a result of the above-discussed, when the outlet of the chamber 11 is opened, the liquid suspended treated material 15 may be discharged under desired and adjusted conditions, into a receptor, without explosive depressurization due to high temperature gradient.

Indeed, the different components of the discharge system 9, such as the level detectors 29, 31, the temperature gages 35, the control system 33, the pump 13, the valve 27, and the like, are preferably intended and operated so as to ensure that the liquid suspended treated material 15 discharged from the chamber 11 is never depressurized violently because a minimum temperature level is always ensured which will thus avoid the bursting of the cells of the treated material. Furthermore, the different components of the discharge system 9, and the injecting of liquid via the pump 13, are preferably selected so as to ensure that the liquid suspended treated material 15 is at a suitable temperature, so as to avoid an abrupt evaporation of the treated material which would risk a cellular bursting of the treated material.

Following is a typical example of raw material treated by the apparatus 1 according to the present invention. Indeed, material to be treated, such as cellulosic fibers, are preferably introduced in a humid,configuration, for example at about 40% in weight, into the feed system 3. The material is then fed into the reactor 5, which preferably contains steam at about 220° C. and operates at about 350 psi, these fibers being transported inside the reactor 5 by the transferring conveyor 7, during a predetermined time, which is preferably calculated according to the speed of rotation of the endless screw. At the end of the reactor 5, the helix portion of the reactor 5 changes in direction over a predetermined length in order to avoid any accumulation of the product at the end of the reactor 5 which would lead to a excessive exposure to cooking and also give rise to degradation products which could contaminate the reactor 5. At the same level, there is found the inlet to the chamber 11 of the discharge system 9, said chamber 11 intended to cool and put the treated material in liquid suspension. The treated material falls into this chamber 11 by means of the converging helix portions of the conveyor 7 and is fed by water at a certain temperature, for example at 10° C. The water is inserted into the chamber 11 via a pump 13 with positive displacement which can overcome the pressure of the reactor 5 and corresponding chamber 11, which is typically located at around 400 psi. The treated product, enters thus in contact with the water, and forms a suspension which is cooled in the chamber 11. As a liquid is injected into the chamber 11, the level of liquid suspended treated material 15 raises, and when said level reaches the high level detected by the high level detector 31, the latter sends a signal to the control system 33 which activates the opening of the discharge valve 27 located at the outlet of the chamber 11.

Thus, as can be easily appreciated, from the aforementioned example, the apparatus 1 according to the present invention enables to introduce material to be treated into the reactor 5, in a humid state, via the feed system 3, without loosing substantial pressure, at about 200° C. for example, and then to have it treated (i.e. “cooked”) at about 200° C., at a pressure of about 350 psi with steam for example, and then, for it to be transferred into an aqueous environment while keeping it in pressure conditions of about 350 psi and cooling it to about 80° C., or less, and have a discharging thereof via the discharge valve 27 towards a receptor at atmospheric pressure and at a temperature of about 80° C. or less, so as to have a temperature gradient between the discharging treated material and that of the ambient environment which is such that the treated material discharged is not subject to explosive depressurization.

It is to be understood that several modifications could be made to the present apparatus 1 according to the present invention without departing from the scope of the present invention. Indeed, as aforementioned, the level detectors 29, 31 of the chamber 11 of the discharge system 9 may come in different forms, as apparent to a person skilled in the art, such as a capacitance level, a conductive level switch, a float level, ultrasonic means, microwave means, differential pressure transmitter, vibrating blade level, consistency transmitter, and the like.

Furthermore, in order to regulate or depressurize the liquid suspended treated material 15 discharged from the system, various types of valves 27, such as ball valves 27 for example, or any other types of suitable valves with rapid action, as apparent to a person skilled in the art, may be used, as well as a piping of smaller diameter in order to create a loss of pressure, as well as a rotary valve, or a pump coupled to an hydraulic, mechanical or magnetic brake, so as to evacuate the liquid similarly to what is possible with a rotary valve, for example, as also apparent to a person skilled in the art.

In regards to the discharge system 9, it is worth mentioning that the latter may be provided with an activator connected to the control system 33 for selectively activating the pump 13, for enabling to stop the pump 13 during the discharging phase, for example. Moreover, the discharge system 9 may be provided with a timer, so as to, for example, substitute the low level detector 29 by activating the discharge valve 27, and thus assuring the same function, during operation, while being less expensive. Moreover, as aforementioned, the discharge system 9 may be provided with a plurality of temperature sensors 35, which would enable to control more precisely the temperature of the liquid suspended treated material 15 inside the chamber 11. In addition, a plurality of inlets may be provided along the chamber 11 for injecting liquid at various locations, which would enable to equilibrate the temperatures of the liquid suspended treated material 15 inside the chamber 11 and also facilitate the transferring thereof towards a receptor.

The apparatus 1 and corresponding parts are preferably made of substantially rigid materials, such as metallic materials (stainless steel, etc.), hardened polymers, composite materials, and/or the like, so as to ensure a proper operation thereof depending on the particular applications for which the apparatus 1 is intended and the different parameters in cause, as apparent to a person skilled in the art.

According to another aspect of the present invention, there is provided a method for treating material, such as lignocellulose material, fibrous material, particulate material, cellulosic material, and the like. The method comprising the steps of a) feeding the material into a reactor 5; b) conveying the material inside the reactor 5 along the same for treating said material; c) transferring the material treated by the reactor 5 into a chamber 11; d) pumping liquid into the chamber 11 so as to obtain a liquid suspended treated material 15 in the chamber 11; and e) discharging the liquid suspended treated material 15 from the chamber 11.

Preferably, step b) further comprises the step of injecting a gaseous reagent into the reactor 5 for treating the material.

Preferably also, step e) comprises the steps of i) measuring parameters of the liquid suspended treated material 15 present in the chamber 11; and ii) discharging the liquid suspended treated material 15 from the chamber 11 when the parameters measured in step i) correspond to predetermined threshold values. Preferably also, the parameters are selected from the group of level, temperature, and degree of liquid suspension.

Preferably also, step a) may comprise the step of impregnating the material with at least one reagent.

As may now be better appreciated, the present invention is a substantial improvement and presents several advantages over devices and/or methods known on the prior art, in that, as aforementioned, it a) limits the losses of pressure and/or gaseous reagent(s); b) maintains a greater stability of the reactor 5 by avoiding the exiting of gaseous reagent(s) through the discharge valve 27; c) avoids the abrupt discharging of the treated material thanks to the substantial cooling and liquid suspending of the treated material in the discharge system 9; d) avoids the displacement by flow back of the product into the reactor 5, which is typical to abrupt discharging, this would indeed change the cooking time for a portion of the product and thus lead to an non-homogeneous product; e) prevents the bursting of the cells of the treated material; f) limits at a minimum the losses of volatiles and the losses of solids during the discharging; and g) avoids the violent impacting at the discharging stage, thereby avoiding the deterioration of parts and components of the system.

The present invention is also advantageous in that, as may now be easily understood, the components and synchronization thereof enable the present apparatus 1 to control the discharging of treated material treated by means of gaseous reagents under pressure, by a transfer of these treated materials into an aqueous environment which is pressurized, and then by controllably discharging the latter into atmospheric conditions in an aqueous environment without an abrupt depressurization of the water contained in the liquid suspended treated material 15, out of the apparatus 1. Furthermore, the present invention is also a substantial improvement over the prior art in that as can now be easily understood, the present apparatus 1 namely enables to not only treat a solid in the presence of high pressure steam, but also enables to cool off the treated material resulting therefrom in order to suitably enable to discharge the same without explosive depressurization, and thus maintaining the structural integrity and characteristics of the treated material, which is very desirable.

Of course, numerous modifications could be made to the above-described embodiments without departing the scope of the invention, as defined in the appended claims.

1. An apparatus for treating material, said apparatus comprising:
a feed system having an inlet for receiving the material from a supply source and an outlet for releasing the material;
a reactor for treating the material, the reactor having an inlet connected to the outlet of the feed system for receiving the material released from the feed system, and an outlet for releasing the material treated by the reactor;
a conveyor located inside the reactor for conveying the material from the inlet of the reactor to the outlet thereof; and
a discharge system for discharging the material, the discharge system including:
a chamber having an inlet connected to the outlet of the reactor for receiving the material treated by the reactor, and an outlet; and
a pump connected to the chamber for pumping liquid into the chamber so as to put the treated material received from the reactor in liquid suspension, thereby obtaining a liquid suspended treated material, said liquid suspended treated material being dischargeable from the apparatus through the outlet of the chamber.

2. An apparatus according to claim 1, wherein the outlet of the chamber is provided with a valve, said valve being operable between a closed configuration for preventing discharging of the liquid suspended treated material from the chamber and an opened configuration for allowing discharging of the liquid suspended treated material from the chamber.

3. An apparatus according to claim 1, wherein the chamber comprises a first sensor for detecting when the liquid suspended treated material is at a first level within the chamber.

4. An apparatus according to claim 3, wherein the chamber comprises a second sensor for detecting when the liquid suspended treated material is at a second level within the chamber, said second level being located at a higher level than the first level.

5. An apparatus according to claim 4, further comprising a control system for operating the valve in the opened configuration upon reception of a signal from the second sensor when the liquid suspended treated material inside the chamber reaches the second level, and for operating the valve in the closed configuration upon reception of a signal from the first sensor when the liquid suspended treated material inside the chamber falls to the first level.

6. An apparatus according to claim 2, further comprising a control system provided with a timer for alternatively operating the valve in the opened and closed configurations during predetermined time intervals.

7. An apparatus according to claim 2, wherein the chamber is provided with a least one temperature sensor for measuring the temperature of the liquid suspended treated material inside the chamber, and wherein the apparatus further comprises a control system for alternatively operating the valve in the opened and closed configurations upon reception of signals from the at least one temperature sensor according to predetermined temperatures values measured by said at least one temperature sensor.

8. An apparatus according to claim 1, wherein the material is selected from the group consisting of lignocellulose material, fibrous material, particulate material, cellulosic material, and the like.

9. An apparatus according to claim 1, wherein the reactor comprises a pressurized vessel provided with at least one peripheral inlet for receiving a gaseous reagent for treating the material inside the vessel of the reactor.

10. An apparatus according to claim 9, wherein the gaseous reagent is steam.

11. An apparatus according to claim 1, wherein the liquid is water.

12. An apparatus according to claim 1, wherein the conveyor is a screw conveyor driven by a variable speed motor.

13. A method for treating material, the method comprising the steps of:
a) feeding the material into a reactor;
b) conveying the material inside the reactor along the same for treating said material;
c) transferring the material treated by the reactor into a chamber;
d) pumping liquid into the chamber so as to obtain a liquid suspended treated material in the chamber; and
e) discharging the liquid suspended treated material from the chamber.

14. A method according to claim 13, wherein step b) further comprises the step of injecting a gaseous reagent into the reactor for treating the material.

15. A method according to claim 13, wherein step e) comprises the steps of:
i) measuring parameters of the liquid suspended treated material present in the chamber; and
ii) discharging the liquid suspended treated material from the chamber when the parameters measured in step i) correspond to predetermined threshold values.

16. A method according to claim 15, wherein the parameters are selected from the group of level, temperature, and degree of liquid suspension.

17. A method according to claim 13, wherein step a) comprises the step of impregnating the material with at least one reagent.

18. A method according to claim 13, wherein the material is selected from the group consisting of lignocellulose material, fibrous material, particulate material, cellulosic material, and the like.

19. An apparatus for treating lignocellulose material, said apparatus comprising:
a feed system having an inlet for receiving the material from a supply source at ambient pressure conditions and an outlet for releasing the material under pressurized conditions;
a reactor for treating the material under pressurized conditions, the reactor having an inlet connected to the outlet of the feed system for receiving the material released from the feed system, and an outlet for releasing the material treated by the reactor under pressurized conditions;
a conveyor located inside the reactor for conveying the material from the inlet of the reactor to the outlet thereof; and
a discharge system for discharging the material, the discharge system including:
a chamber under pressurized conditions having an inlet connected to the outlet of the reactor for receiving the material treated by the reactor, and an outlet; and
a pump connected to the chamber for pumping liquid into the chamber under pressurized conditions so as to put the treated material received from the reactor in liquid suspension, thereby obtaining a liquid suspended treated material, said liquid suspended treated material being dischargeable from the apparatus into ambient pressure conditions through the outlet of the chamber.
